(19) United States
(12) Patent Application Publication
(10) Pub. No.: US 2024/0409454 A1
(43) Pub. Date: Dec. 12, 2024

(54) SYSTEM AND ASSOCIATED METHODS

(71) Applicant: AGC GLASS EUROPE, Louvain-la-Neuve (BE)

(72) Inventor: Mohsen YOUSEFBEIKI, Gosselies (BE)

(73) Assignee: AGC GLASS EUROPE, Louvain-la-Neuve (BE)

(21) Appl. No.: 18/707,084

(22) PCT Filed: Nov. 22, 2022
(86) PCT No.: PCT/EP2022/082731

§ 371 Date: May 2, 2024

(30) Foreign Application Priority Data
Nov. 25, 2021 (EP) 21210622.3

(51) Int. Cl. C03C 17/00; H01Q 15/08

(52) U.S. Cl. CPC C03C 17/002; H01Q 15/08; C03C 2218/34

(57) ABSTRACT

A system comprising a dielectric substrate and a coating system disposed on the dielectric substrate is described. The coating system comprises a Fresnel zone plate lens composed of n coaxial elliptical zones CEZn, n being a positive integer and numbered from 1 to N (n=1, 2, 3, . . . , N wherein N is a positive integer greater than or equals to 2 (N≥2)) defining odd and even coaxial elliptical zones. The odd coaxial elliptical zones are partially decoated with a specific odd decoating pattern and/or the even coaxial elliptical zones are partially decoated with a specific even decoating pattern. A method to decoat and a method to use the system to focalize an incident EM wave having wavelengths between 0.3 GHz and 110 GHz through the system to an indoor equipment at a desired location is also described.

### TECHNICAL FIELD

The present application relates to a system comprising a dielectric substrate and a coating system on at least a part of the dielectric substrate to focalize to a desired location incident electromagnetic (EM) waves, especially radio-frequency (RF) waves, having wavelengths between about 300 MHz up to about 110 GHz, through the system meaning from one side to the other side of the system.

### BACKGROUND ART

In modern buildings and vehicles, the demand for thermal comfort increases while sizes of openings, such as glazing units, also increase.

The use of multiple glazing can increase this thermal comfort.

Multiple glazing means a glazing unit with at least two glazing panels combined together by a means of maintaining the two glazing panels at a certain distance between the two glazing panels. The glazing panel placed outside of the building is called the outer glazing panel where the other one is called the inner glazing panel. To maintain the two glazing panels at a certain distance one from the other, a spacer can be used in the periphery of the glazing unit with gas in the volume created between these two glazing panels, pillars can be used between the two glazing panels and a vacuum is created between these two glazing panels, called vacuum insulated glazing (VIG). Usually, surfaces of glazing panels have two main surfaces, one is oriented towards the outside of the building, vehicle, . . . , the external surface, while the other surface is oriented towards the inside of the building, vehicle, . . . , the internal surface.

The thermal comfort can be increased by managing the quantity of heat passing through a window.

In order to reduce the accumulation of heat in the interior of a building or vehicle, the glazing unit may be coated with a coating system, for example a solar control coating system, that absorbs or reflects solar energy. Inclusion of solar control films, particularly on glazing for use in warm, sunny climates, is desirable because they reduce the need for air conditioning or other temperature regulation methods. This affords savings in terms of energy consumption and environmental impact.

To ensure the thermal comfort inside the building or vehicle, a coating system such as a low-emissivity coating can be provided on at least one of the inner surfaces of the two glazing panels.

Such coating systems, however, are typically electrically conductive and are highly reflective for Radio Frequency (RF) waves and very low in transmittance for RF waves. This effect impedes efficient radio-frequency wireless communication to be established between the wireless devices indoors and outdoors.

This makes the coating systems efficient and broadband reflectors of radio frequency signals. Furthermore, commercial construction, automotive, train, . . . tend to use other materials that further block RF signals. Materials such as concrete, brick, mortar, steel, aluminum, roofing tar, gypsum wall board, and some types of wood all offer varying degrees of RF attenuation. The result is that many newer constructions severely impede RF signals from getting into or out of the buildings.

Nonetheless, RF devices have become an important part of modern life, especially with the huge penetration of cellular smartphones, tablets, IoT (Internet of Things) devices, that are requiring a deep penetration in buildings or automotive of electromagnetic field for indoor coverage, even at high spectrum frequency up to 70 GHz. The ITU IMT-2020 specification demands speeds up to 20 Gbps, achievable with wide channel bandwidths and massive MIMO 3rd Generation Partnership Project (3GPP) is going to submit 5G NR (New Radio) as its 5G communication standard proposal. 5G NR can include lower frequencies, below 6 GHz, and mm-Wave, above 15 GHz. On top of that, IoT will requires indoor coverage as good as possible not for massive MTC (Machine Type Communication) but for critical MTC where robots or industrial devices are 5G wireless remotely controlled.

At mm-Wave, the signal level rapidly decreases due to high path loss. Many residential/commercial buildings therefore need outdoor, or outdoor-indoor repeaters and indoor CPEs (Customer-Premises Equipments). On top of that, an outdoor unit is typically undesirable for security reasons but also to provide easily power or to avoid environmental conditions that can damage the outdoor unit.

In case of an indoor equipment, such as a CPE and/or a repeater, is placed inside the building, the signal is attenuated by at least 30 dB through glazing unit with a typical coated window. This impedes a stable connection to the outdoor base station.

Some solutions provide a decoating portion on the coated window. This decoating portion improves the signal inside the building but creates a narrow field of view. Especially at mm-Wave frequencies, beamforming is important to improve the signal to interference ratio (SIR) also because obstacles cause greater diffusion of the signal and less specular reflection meaning that there is higher propagation losses in NLOS. This entails placing the repeater and/or the CPE exactly in front of the decoating portion or at a very close distance from the decoating portion. However, this constraint can be impractical as the aesthetic and technical requirements are not met.

These solutions, to provide a greater field of view, need a greater decoating portion at the expense of further degradation in thermal performances of the glazing unit.

### SUMMARY OF INVENTION

The present invention permits to solve these issues.

Especially, the present invention permits to minimize the decoating portion compared to existing solutions while increasing the chance to provide stronger wireless link between an indoor equipment and a base station or an outdoor repeater through the glazing unit at radio frequencies below 6 GHz and mm-Wave.

The invention also permits a greater field of view for frequencies between about 300 MHz up to about 110 GHz.

The present invention relates, in a first aspect, to a system comprising a dielectric substrate and a coating system disposed on the said dielectric substrate.

The solution as defined in the first aspect of the present invention is based on that the coating system comprises a Fresnel zone plate lens (10) composed of N coaxial elliptical zones CEZn (CEZ1, CEZ2, CEZ3, CEZ4, CEZ4, CEZ5, CEZ6, CEZ7, CEZ8), n being a positive integer and numbered from 1 to n (n=1, 2, 3, . . . , N wherein N is a positive integer greater than or equals to 2 (N≥2)) defining odd (CEZ1, CEZ3, CEZ5, CEZ7, . . . ) and even (CEZ2, CEZ4, CEZ6, CEZ8, . . . ) coaxial elliptical zones.

The solution is also based on that the odd coaxial elliptical zones (CEZ1, CEZ3, CEZ5, CEZ7, . . . ) are partially decoated with a specific odd decoating pattern, meaning that each of the odd coaxial elliptical zones are partially decoated with the same specific odd decoating pattern, and/or the even coaxial ellipse zones (CEZ2, CEZ4, CEZ6, CEZ8, . . . ) are partially decoated with a specific even decoating pattern, meaning that each of the even coaxial elliptical zones are partially decoated with the same specific even decoating pattern.

The present invention relates, in a second aspect, to a method to decoat a Fresnel zone plate lens comprised on a coating system disposed on a dielectric substrate.

The solution as defined in the second aspect of the present invention is based on that the Fresnel zone plate lens is composed of N coaxial elliptical zones CEZn (CEZ1, CEZ2, CEZ3, CEZ4, CEZ4, CEZ5, CEZ6, CEZ7, CEZ8), CCZn (CCZ1, CCZ2, CCZ3, CCZ4, CCZ4, CCZ5, CCZ6, CCZ7, CCZ8), n being a positive integer and numbered from 1 to n (n=1, 2, 3, . . . , N wherein N is a positive integer greater than or equals to 2 (N≥2)) defining odd (CEZ1, CEZ3, CEZ5, CEZ7, . . . , CCZ1, CCZ3, CCZ5, CCZ7, . . . ) and even (CEZ2, CEZ4, CEZ6, CEZ8, . . . , CCZ2, CCZ4, CCZ6, CCZ8, . . . ) coaxial elliptical zones.

This solution is also based on that the method comprises an odd decoating step of partially decoating the odd coaxial elliptical zones with a specific odd decoating pattern and/or an even decoating step of partially decoating the even coaxial elliptical zones with a specific even decoating pattern.

The present invention relates, in a third aspect, to a use of a system according to the first aspect of the present invention to focalize an incident EM wave having wavelengths between 0.3 GHz and 110 GHz through the system to a desired location where an indoor equipment, such as customer-premises equipment (CPE), a repeater or alike, placed on the other side of the dielectric panel than the incident EM wave.

Thus, the present invention, in the first, second and third aspect, permits to focalize an incident EM wave having wavelengths between 0.3 GHz and 110 GHz through the system to a desired location on the other side from the side of the incoming EM wave.

The present invention increases the signal strength received by a receiver placed at the desired location.

The present invention allows to reduce the decoating portion for a specific received signal strength required by a receiver placed at the desired location.

Therefore, the present invention solves the need to have a large decoating portion on the dielectric substrate for a reliable wireless link and/or the need to utilize high power transmitters and high sensitivity receivers to keep high performance wireless communication.

It is an object of the present invention to alleviate the above described problems and to solve the need to place high performance equipment such as customer-premises equipment or repeaters behind a glazing panel with boosted communication performances and with reduced decoated portion.

It is noted that the invention relates to all possible combinations of features recited in the claims or in the described embodiments.

The following description relates to building and vehicle glazing applications but it's understood that the invention may be applicable to others fields like transportation applications, other road users and/or services.

### BRIEF DESCRIPTION OF THE DRAWINGS

This and other aspects of the present invention will now be described in more details, with reference to the appended drawings showing various exemplifying embodiments of the invention which are provided by way of illustration and not of limitation. The drawings are a schematic representation and not true to scale. The drawings do not restrict the invention in any way. More advantages will be explained with examples.

FIG. 1 is a schematic view of a system arranged in its environment according to the first aspect of the invention.

FIG. 2 is a schematic 3D view of a system with an indoor equipment 200

FIG. 3 is a schematic view of a system according to the first aspect of the invention in the x-y plane.

FIG. 4 is a schematic view of a system according to the first aspect of the invention in the y-z plane.

FIG. 5 is a schematic view of a Fresnel zone plate lens composed of N coaxial elliptical zones according to the invention.

FIG. 6 is a schematic view of a Fresnel zone plate lens where the odd coaxial elliptical zones are partially decoated with a specific odd decoating pattern according to some embodiments of the present invention.

FIG. 7 is a schematic view of a Fresnel zone plate lens where the odd coaxial elliptical zones are partially decoated with a specific odd decoating pattern and the even coaxial elliptical zones are partially decoated with a specific even decoating pattern according to some other embodiments of the present invention.

FIG. 8 is a schematic view of a Fresnel zone plate lens where the N coaxial elliptical zones are concentric circular zones and where the even concentric circular zones are partially decoated with a specific even decoating pattern according to some other embodiments of the present invention.

FIG. 9 is a schematic view of a Fresnel zone plate lens where the N coaxial elliptical zones are concentric circular zones and where the odd concentric circular zones are partially decoated with a specific odd decoating pattern and the even concentric circular zones are partially decoated with a specific even decoating pattern according to some other embodiments of the present invention.

FIG. 10 is a schematic view of a decoating step using a laser.

### DETAILED DESCRIPTION

This and other aspects of the present invention will now be described in more details, with reference to the appended drawings showing various exemplifying embodiments of the invention which are provided by way of illustration and not of limitation. The drawings are a schematic representation and not true to scale. The drawings do not restrict the invention in any way. More advantages will be explained with examples.

For a better understanding, the scale of each member in the drawing may be different from the actual scale. In the present specification, a three-dimensional orthogonal coordinate system in three axial directions (X axis direction, Y axis direction, Z axis direction) is used, the longitudinal direction of the system is defined as the X direction, the height is defined as the Y direction and the transversal direction is defined as the Z direction. The incoming EM wave is coming from generic direction −Z to Z.

In this document to a specific embodiment and include various changes, equivalents, and/or replacements of a corresponding embodiment. The same reference numbers are used throughout the drawings to refer to the same or like parts.

As used herein, spatial or directional terms, such as “inner”, “outer”, “above”, “below”, “top”, “bottom”, and the like, relate to the invention as it is shown in the drawing figures. However, it is to be understood that the invention can assume various alternative orientations and, accordingly, such terms are not to be considered as limiting. Further, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims are approximations that can vary depending upon the desired properties sought to be obtained by the present invention. In the following description, unless otherwise specified, expression “substantially” mean to within 10%, preferably to within 5%.

Moreover, all ranges disclosed herein are to be understood to be inclusive of the beginning and ending range values and to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Further, as used herein, the terms “deposited over” or “provided over” mean deposited or provided on but not necessarily in surface contact with. For example, a coating “deposited over” a substrate does not preclude the presence of one or more other coating films of the same or different composition located between the deposited coating and the substrate.

Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated. In this document, “configured to (or set to)” may be interchangeably used in hardware and software with, for example, “appropriate to”, “having a capability to”, “changed to”, “made to”, “capable of”, or “designed to” according to a situation. In any situation, an expression “device configured to do” may mean that the device “can do” together with another device or component.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein. When it is described that a constituent element (e.g., a first constituent element) is “(functionally or communicatively) coupled to” or is “connected to” another constituent element (e.g., a second constituent element), it should be understood that the constituent element may be directly connected to the another constituent element or may be connected to the another constituent element through another constituent element (e.g., a third constituent element).

The present invention, according to the first aspect, provides a system according to the first aspect of the invention. The system is designed to be placed in an environment.

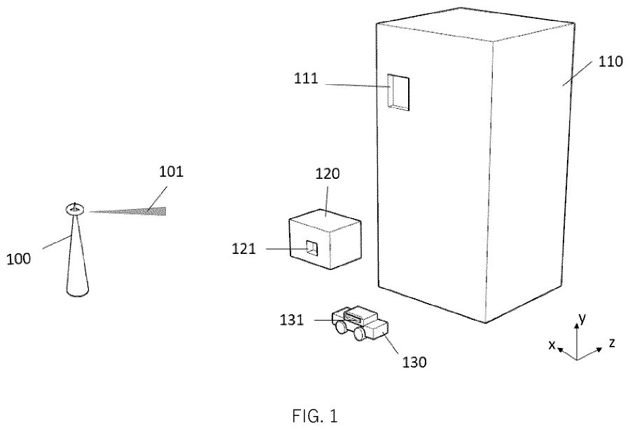

As illustrated in FIG. 1, the system 111, 121, 131 is placed in situ meaning that the system is already mounted on a stationary object, for instance a building 110, 120, or mounted on a mobile object 130, for instance a vehicle, a train.

A base station or an outdoor repeater 100 emits EM waves 101 in multiple directions. The system 111, 121, 131 is facing a direct EM wave or indirect EM wave, a direct EM wave reflected by any means able to reflect such EM waves to another direction.

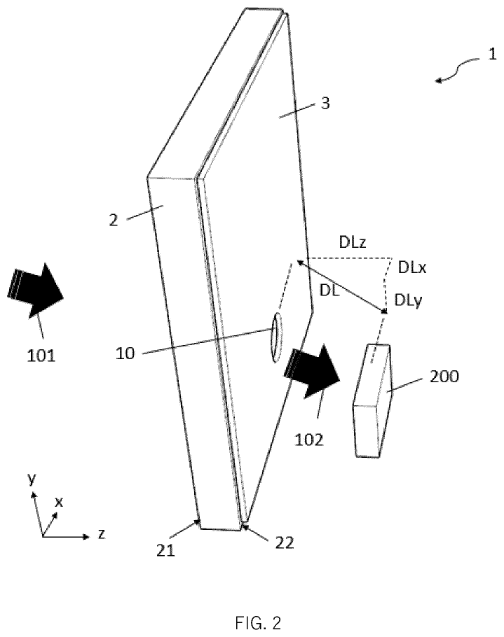

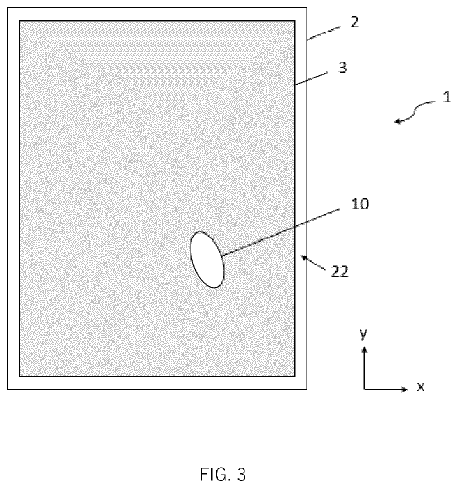

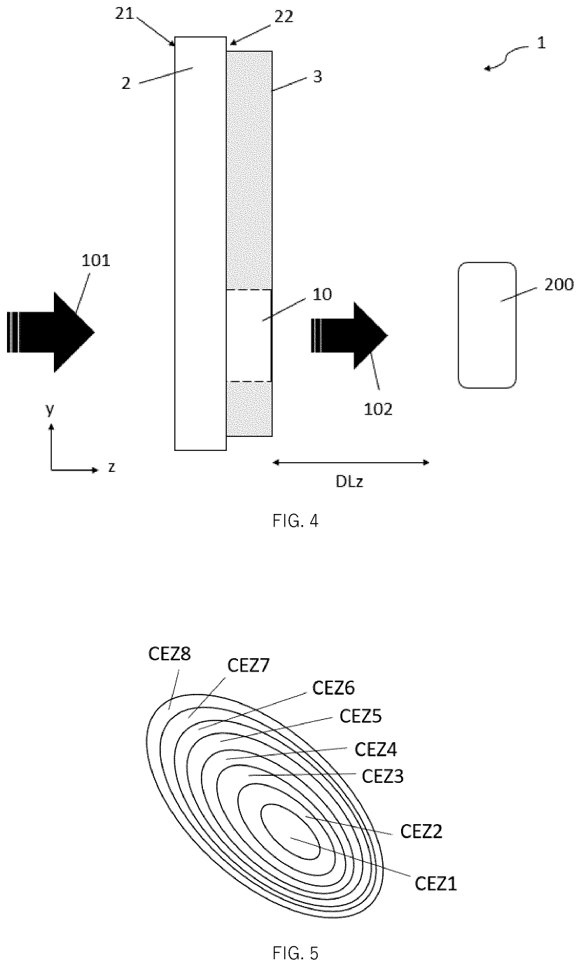

As illustrated in FIGS. 2 to 4 the system 1 as shown in FIG. 1 comprises a dielectric substrate 2, substantially in the x-y plane, with a thickness in the z-axis. The dielectric substrate 2 has an exterior face 21, facing the exterior of the stationary or mobile object and an interior face 22. It means that the exterior face 21 is the face by which the EM wave 101 coming from the base station 100 first touches the system 1.

In some embodiments, the dielectric substrate 2 is at least transparent for visible waves in order to see-through and to let visible light passing through, meaning that the light transmission is greater than or equal to 1%.

According to the invention, the dielectric substrate 2 can be a glazing panel creating a window or alike.

In some preferred embodiments, the glazing panel comprises at least one glass sheet.

In some preferred embodiments, the glazing panel comprises at least two glass sheets separated by a spacer allowing to create a space filled by a gas like Argon to improve the thermal isolation of the glazing panel, creating an insulating glazing panel.

In some preferred embodiments, the glazing panel comprises at least two glass sheets separated by spacers allowing to create a vacuum space to improve the thermal isolation of the glazing panel, creating a vacuum insulating glazing (VIG).

In the present embodiment, the rectangle includes not only a rectangle or a square but also a shape obtained by chamfering corners of a rectangle or a square. The shape of the glazing panel 10 in a plan view is not limited to a rectangle, and may be a circle or the like.

In some embodiments, the glazing panel can be a laminated glazing panel to reduce the noise and/or to ensure the penetration safety. The laminated glazing comprises glazing panels maintained by one or more interlayers positioned between glazing panels. The interlayers employed are typically polyvinyl butyral (PVB) or ethylene-vinyl acetate (EVA) for which the stiffness can be tuned. These interlayers keep the glazing panels bonded together even when broken in such a way that they prevent the glass from breaking up into large sharp pieces.

In embodiments where the glazing panel comprises several glass sheets, different or same coating systems can be placed on different surfaces of the glass sheets.

As the material of the glazing panel, for example, soda-lime silica glass, borosilicate glass, or aluminosilicate glass can be mentioned or other materials such as thermoplastic polymers, polycarbonates are known, especially for automotive applications, and references to glass throughout this application should not be regarded as limiting.

The glazing panel can be manufactured by a known manufacturing method such as a float method, a fusion method, a redraw method, a press molding method, or a pulling method. As a manufacturing method of the glazing panel 2, from the viewpoint of productivity and cost, it is preferable to use the float method.

The glazing panel 2 can be flat or curved according to requirements by known methods such as hot or cold bending.

The glazing panel 2 can be processed, i.e. annealed, tempered, . . . to respect with the specifications of security and anti-thief requirements.

The glass sheet can be a clear glass or a colored glass, tinted with a specific composition of the glass or by applying an additional coating or a plastic layer for example.

In case of several glass sheets, in some embodiments, each glass sheet can be independently processed and/or colored, . . . in order to improve the aesthetic, thermal insulation performances, safety, . . . .

The thickness of the glazing panel is set according to requirements of applications.

The glazing panel can be formed in a rectangular shape in a plan view by using a known cutting method. As a method of cutting the glazing panel, for example, a method in which laser light is irradiated on the surface of the glazing panel to cut the irradiated region of the laser light on the surface of the glazing panel to cut the glazing panel, or a method in which a cutter wheel is mechanically cutting can be used. The glazing panel can have any shape in order to fit with the application, for example a windshield, a sidelite, a sunroof of an automotive, a lateral glazing of a train, a window of a building, . . . .

In addition, the glazing unit can be assembled within a frame or be mounted in a double skin façade, in a carbody or any other means able to maintain a glazing unit. Some plastics elements can be fixed on the glazing panel to ensure the tightness to gas and/or liquid, to ensure the fixation of the glazing panel or to add external element to the glazing panel.

In some embodiments, the dielectric substrate can comprises a thin film, having a thickness comprises between 20 μm and 300 μm, preferably the thickness is about 100 μm. This thin film can be a PET film or any other suitable film. In some embodiments, the thin film is fixed on a surface of a glazing panel by a glue, by electrostatic or by any other suitable way to fix a thin film on a surface.

The system 1 further comprises a coating system 3 disposed on the dielectric substrate 2.

The coating system is high in reflectance and low in transmittance for RF radiation. Low in transmittance means a transmission with an attenuation at level of 20 decibels (dB) or more. It is understood that the dielectric substrate is low in reflectance, meaning an attenuation at level of 10 decibels (dB) or less.

According to the invention, the coating system 3 can be a functional coating in order to heat the surface of the dielectric panel, to reduce the accumulation of heat in the interior of a building or vehicle or to keep the heat inside during cold periods for example. Although coating system are thin and mainly transparent to eyes in order to see-through and to let visible light passing through.

The coating system 3 can be made of layers of different materials and at least one of this layer is electrically conductive. The coating system is electrically conductive over the majority of one major surface of the dielectric panel, in the x-y plane.

The coating system 3 of the present invention has an emissivity of not more than 0.4, preferably less than 0.2, in particular less than 0.1, less than 0.05 or even less than 0.04. The coating system of the present invention may comprise a metal based low emissive coating system; these coatings typically are a system of thin layers comprising one or more, for example two, three or four, functional layers based on an infrared radiation reflecting material and at least two dielectric coatings, wherein each functional layer is surrounded by dielectric coatings. The coating system of the present invention may in particular have an emissivity of at least 0.010. The functional layers are generally layers of silver with a thickness of some nanometres, mostly about 5 to 20 nm. Concerning the dielectric layers, they are transparent and traditionally each dielectric layer is made from one or more layers of metal oxides and/or nitrides. These different layers are deposited, for example, by means of vacuum deposition techniques such as magnetic field-assisted cathodic sputtering, more commonly referred to as “magnetron sputtering”, or Chemical deposition such as CVD or PECVD or any other known deposition method. In addition to the dielectric layers, each functional layer may be protected by barrier layers or improved by deposition on a wetting layer.

In some embodiments, the coating system 3 is applied to the dielectric substrate 2, especially a glazing panel, to transform it to a low-E glazing unit. This metal-based coating system such as low-E or heatable coating systems.

In some embodiments, the coating system 3 can be a heatable coating applied on the dielectric substrate, especially a glazing panel, to add a defrosting and/or a demisting function for example.

As the coating system, for example, a conductive film can be used. As the conductive film, for example, a laminated film obtained by sequentially laminating a transparent dielectric, a metal film, and a transparent dielectric, ITO, fluorine-added tin oxide (FTO), or the like can be used. As the metal film, for example, a film containing as a main component at least one selected from the group consisting of Ag, Au, Cu, and Al can be used.

Preferably, the coating system is placed on the majority of one surface of the glazing unit and more preferably on the whole usable surface of the glazing panel, in the x-y plane.

In some embodiments, a masking element, such as an enamel layer, can be add on a part of the periphery of the glazing unit to hide the transition between a coated area and an non-coated area.

In FIGS. 2 to 4, representing one embodiment, the coating system is deposited on the internal face 22 of the dielectric substrate 2.

In embodiments in which the dielectric substrate comprises several panels, the coating system or the several coating systems can be placed on any surface of panels and preferably not an the exterior face 21.

In some embodiments, a coating system can be placed on the exterior face 21 to increase the anti-fogging performances of the system 1.

The coating system comprises a Fresnel zone plate lens 10 that allows the low-attenuation transmission of the EM waves 101 from the base station 100 and focalizes them at a defined location where an indoor equipment 200, such as a customer-premises equipment or a repeater, is positioned. It is understood that if there is other coating systems parallel to the coating system 3 that affects the transmission of incident wave towards the focus, it is preferred to make those coating system low in reflectance by applying a frequency selective surface treatment at least in the path of the incident EM wave. A frequency selective surface can be placed between the indoor equipment and the Fresnel zone plate lens and/or a frequency selective surface can be placed between the base station and the Fresnel zone plate lens.

The indoor equipment 200 is placed at a location opposite to the emission of the EM waves meaning inside the stationary or mobile object. More preferably, the equipment, the incoming wave source and the Fresnel zone plate lens are collinear meaning that they all lie on a single substantially straight line. The indoor equipment is at a defined distance DL from the Fresnel zone plate lens 10. This distance has components along each of the x, y and z axes, respectively DLx, DLy, DLz.

According to the invention, the coating system comprises a Fresnel zone plate lens 10 to focalize an incident EM wave (101) having wavelengths between 0.3 GHz and 110 GHz through the system to a desired location, DL, on the other side.

In some embodiments, the coating system can comprise several Fresnel zone plate lenses 10 to focalize incident waves 101 having the same or different angles of incidence and frequencies and polarizations into the same and/or different locations on the other side, forming one or more focalized EM waves 102.

FIGS. 5 to 10 illustrate some more detailed embodiments of a Fresnel zone plate lens shown in FIGS. 2 to 4, viewed from the +Z side (from the indoor of the object). The Fresnel zone plate lens (10) is composed of N coaxial elliptical zones CEZn (CEZ1, CEZ2, CEZ3, CEZ4, CEZ4, CEZ5, CEZ6, CEZ7, CEZ8), CCZn (CCZ1, CCZ2, CCZ3, CCZ4, CCZ4, CCZ5, CCZ6, CCZ7, CCZ8), n being a positive integer and numbered from 1 to N (n=1, 2, 3, . . . , N wherein N is a positive integer greater than or equals to 2 (N≥2)) defining odd (CEZ1, CEZ3, CEZ5, CEZ7, CCZ1, CCZ3, CCZ5, CCZ7) and even (CEZ2, CEZ4, CEZ6, CEZ8, CCZ2, CCZ4, CCZ6, CCZ8) coaxial elliptical zones.

These N coaxial elliptical zones correspond to a specific surface between coaxial ellipses CEn and CEn−1 (CE1, CE2, CE3, CE4, CE5, CE6, CE7, CE8). This defines odd coaxial ellipses, CE1, CE3, CE5, CE7, and even coaxial ellipses CE2, CE4, CE6, CE8. It is understood that odd and even define coaxial ellipses with respectively an odd or an even number represented by the value n.

In said embodiments, N equals eight (N=8) meaning that eight coaxial elliptical zones CEZ1, CEZ2, CEZ3, CEZ4, CEZ4, CEZ5, CEZ6, CEZ7, CEZ8, CCZ1, CCZ2, CCZ3, CCZ4, CCZ4, CCZ5, CCZ6, CCZ7, CEZ8, and thus eight coaxial ellipses CE1, CE2, CE3, CE4, CE5, CE6, CE7, CE8, are represented. It is understood that this number of coaxial ellipses is not limited to eight but can be from two (N=2) to a number depending of the application.

The number N of coaxial elliptical zones is greater than or equal to two (N≥2). Preferably, this number N is greater than or equal to four (N≥4) to increase the focalizing of the incident EM wave. More preferably, this number N is greater than or equal to six (N≥6) to further increase the focalizing of the incident wave. Even more preferably, this number N is greater than or equal to eight (N≥8) to even more increase the focalizing of the incident wave.

The upper limit of N can be limited by the dimensions of the available surface of the coating system to decoat such coaxial elliptical zones. Preferably, the number N of coaxial elliptical zones is lower than or equal to 20 (N≤20). More preferably, the number N of coaxial elliptical zones is lower than or equal to 16 (N≤16). Even more preferably, the number N of coaxial elliptical zones is lower than or equal to 12 (N≤12) to minimize decoating time and cost.

Coaxial elliptical zones CEZn, CCZn, coaxial ellipses CEn are numbered from the center (n=1) to the external (n=N).

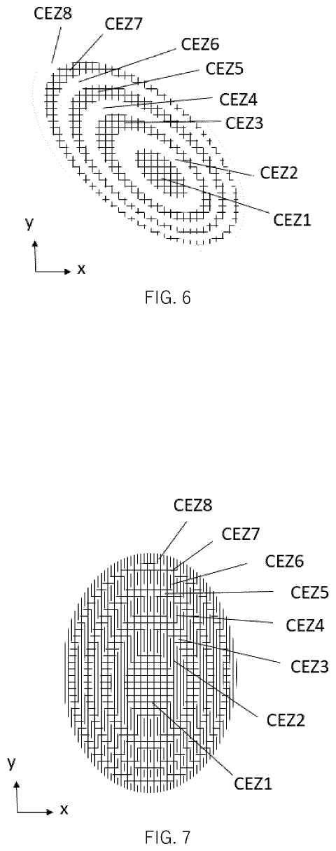

FIGS. 6 to 10 illustrates some embodiments where the odd coaxial elliptical zones, CEZ1, CEZ3, CEZ5, CEZ7, CCZ1, CCZ3, CCZ5, CCZ7 are partially decoated with a specific odd decoating pattern and/or the even coaxial elliptical zones, CEZ2, CEZ4, CEZ6, CEZ8, CCZ2, CCZ4, CCZ6, CCZ8, are partially decoated with a specific even decoating pattern meaning that each of the odd coaxial elliptical zones are partially decoated with the same specific odd decoating pattern and/or each of the even coaxial elliptical zones are partially decoated with the same specific even decoating pattern.

Partially decoated means that at least a part of the electrically conductive layer(s) of the coating system is removed.

Decoating pattern means ablated paths created in the coating system, while leaving behind the coating system in untouched areas and only a very small percentage of the area of the coating system is removed from the glazing panel, and most of the coated surface remains untouched to keep performances of the coating system. The decoating pattern comprises coated and decoated areas.

These ablated paths are produced in such a way as to allow passage of RF signals through the coating system for a given frequency range and polarizations, while keeping areas of the coating system allowing the glazing panel to retain most of its energy conserving properties or heatable properties. This means that the decoating pattern behaves as a low-pass or a band-pass filter for incident EM wave at the given frequency for the given polarization.

In various embodiments, paths can be made by pulse laser to create spots. The diameter of the spot between about 10 μm up to about 50 μm, so that each path will be approximately this width. In alternative embodiments, different sized spots (e.g., 10-200 microns in diameter) and paths may be used. Moreover, the spots overlap and the amount of overlap may be approximately 50% by area; the extent of overlap may vary in alternative embodiments. In some embodiments, the overlap may range from 25% to over 90% for example.

In some embodiments, the decoated area of a coated system may be 5% or less of the total coated area depending of the application, the material used in the glazing unit, . . . . In other embodiments, a different percentage may be used (e.g. 10% or less total area of the coating system removed, and 90% total area of a coating system retaining untouched).

Noted that while ablation of a higher percentage of the area may improve the transmission of RF signals through the glazing unit, ablation of more of the coating system diminishes the energy conserving properties and heatable performances of the glazing unit.

In some embodiments, the specific odd decoating pattern and the specific even decoating pattern are different to allow the focalization while controlling the transparency of the part of the EM wave such as a polarization and/or frequency.

By alternating the opacity and transparency between the odd (CEZ1, CEZ3, CEZ5, CEZ7, CCZ1, CCZ3, CCZ5, CCZ7) and even (CEZ2, CEZ4, CEZ6, CEZ8, CCZ2, CCZ4, CCZ6, CCZ8) coaxial elliptical zones for RF waves for a given frequency range and polarization and angle of incidence, the incident wave diffracted from the Fresnel zone plate lens interferes constructively at the desired focus range. This can be carried out either by making the odd elliptical zones transparent to the incident wave and making the even elliptical zones opaque to the incident wave or making the even elliptical zones transparent to the incident wave and making the odd elliptical zones opaque to the incident wave for the desired polarization(s).

To get constructive interference at the focus, the dimensions and positions of the coaxial ellipses and their corresponding coaxial elliptical zones are determined such that the diffracted contributions from odd and even coaxial ellipses around the opaque zones are completely in-phase to each other at the desired focus. It is understood that the dimensions and positions of coaxial elliptical zones are functions of frequency and the angle of incidence of the incident wave, and the location of the focus. It is also understood that the constructive interference is independent of the absolute phase values. Therefore, all the dimensions and positions of the coaxial ellipses and their corresponding coaxial elliptical zones depends on the reference phase that can be arbitrarily chosen.

When the incoming wave from the external source is normal incident on the glazing panel, the n coaxial ellipses are n concentric circles and correspondingly n coaxial elliptical zones are n concentric circular zones. Accordingly, the radii of the n concentric circles is calculated, corresponding to the calculation step of some embodiments of the second aspect of the present invention, by

$${r}_{n} = \sqrt{\frac{1}{4} {( n + α )}^{2} {λ}_{0}^{2} + ( n + α ) {λ}_{0} D {L}_{Z}}$$

where α is the arbitrary reference phase and λ₀ is the free-space wavelength.

In some embodiments, for a normal incident wave at 28 GHz to be focalized at the distance DLz=30 cm from the coating system, assuming α=0, the radii of the n concentric circles is computed as follows:

| n | 1 | 2 | 3 | 4 | 5 | 6 | 7 | 8 |
|---|---|---|---|---|---|---|---|---|
| rₙ (mm) | 56.9 | 80.9 | 99.5 | 115.4 | 129.6 | 142.5 | 154.6 | 166.0 |

In order to make all odd coaxial elliptical zones transparent to an incoming wave while keeping thermal properties of the coating system, according to the present invention, the odd coaxial elliptical zones, CEZ1, CEZ3, CEZ5, CEZ7, CCZ1, CCZ3, CCZ5, CCZ7, are partially decoated with a specific odd decoating pattern. It is understood that the specific odd decoating pattern can differ from an odd coaxial elliptical zone to other odd coaxial elliptical zone, not limiting i.e., the pattern of CEZ1 is a 1 mm×1 mm grid and the pattern of CEZ3 is a 0.9 mm×0.9 mm grid (it could be the same with any pattern). Although, it is preferred that all odd coaxial elliptical zones are partially decoated with the same specific odd decoating pattern to reduce the decoating cost and time.

In order to make all even coaxial elliptical zones transparent to an incoming wave while keeping thermal properties of the coating system, according to the present invention, the even coaxial elliptical zones, CEZ2, CEZ4, CEZ6, CEZ8, CCZ2, CCZ4, CCZ6, CCZ8, are partially decoated with a specific even decoating pattern. It is understood that the specific even decoating pattern can differ from an even coaxial elliptical zone to other even coaxial elliptical zone, not limiting i.e., the pattern of CEZ2 is a 1 mm×1 mm grid and the pattern of CEZ4 is a 0.9 mm×0.9 mm grid (it could be the same with any pattern). Although, it is preferred that all even coaxial elliptical zones are partially decoated with the same specific even decoating pattern to reduce the decoating cost and time.

As illustrated in FIG. 6, the odd elliptical zones, CEZ1, CEZ3, CEZ5, CEZ7, CCZ1, CCZ3, CCZ5, CCZ7, are partially decoated with a specific odd decoating pattern and the even elliptical zones, CEZ2, CEZ4, CEZ6, CEZ8, CCZ2, CCZ4, CCZ6, CCZ8, are not decoated.

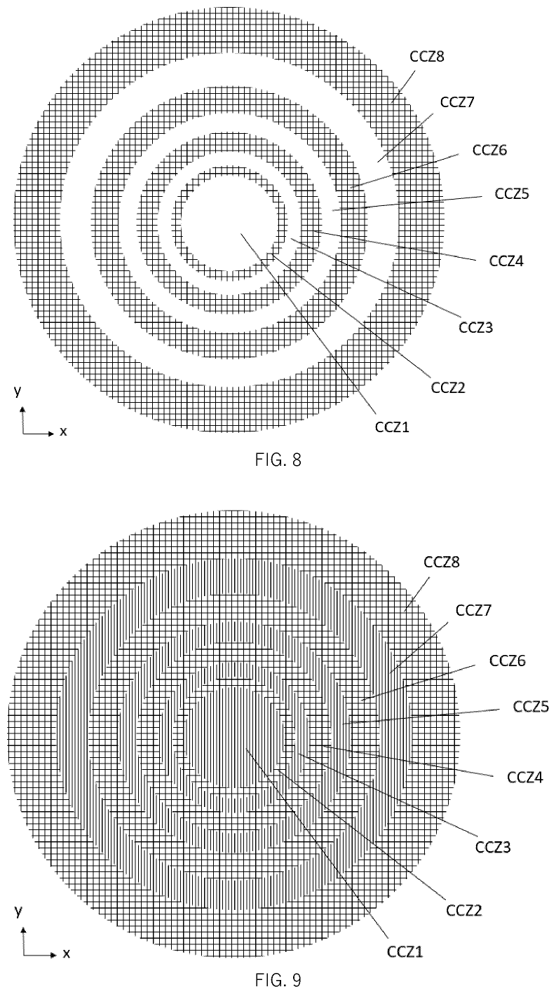

In some others embodiments, as illustrated in FIG. 8, the odd elliptical zones, CEZ1, CEZ3, CEZ5, CEZ7, CCZ1, CCZ3, CCZ5, CCZ7, are not decoated and the even elliptical zones, CEZ2, CEZ4, CEZ6, CEZ8, CCZ2, CCZ4, CCZ6, CCZ8, are partially decoated with a specific even decoating pattern.

As illustrated in FIGS. 7 and 9, the odd elliptical zones, CEZ1, CEZ3, CEZ5, CEZ7, CCZ1, CCZ3, CCZ5, CCZ7, are partially decoated with a specific odd decoating pattern and the even elliptical zones, CEZ2, CEZ4, CEZ6, CEZ8, CCZ2, CCZ4, CCZ6, CCZ8, are partially decoated with a specific even decoating pattern. These embodiments mean that the odd and the even elliptical zones are partially decoated with respectively specific odd and even decoating patterns. It is understood that the odd decoating pattern and the even decoating pattern are different.

According to the invention, decoating patterns can be an interconnected grid, parallel vertical or horizontal or slant lines, cross, hashtag-like or any other design suitable to create a frequency selective surface and to reduce the reflectance of the coating system depending if the transparency is required for both polarizations or for a specific single polarization.

In some embodiments, the specific odd decoating pattern comprises an array of one-dimensional periodic structures, preferably the specific odd decoating pattern comprises parallels lines.

In some embodiments, the specific odd decoating pattern comprises an array of two-dimensional periodic structures, preferably the specific odd decoating pattern comprises a grid or an array of open or closed slots or any other design suitable to reduce the reflectance of the coating system.

In some embodiments, the specific even decoating pattern comprises an array of one-dimensional periodic structures, preferably the specific even decoating pattern comprises parallels lines.

In some embodiments, the specific even decoating pattern comprises an array of two-dimensional periodic structures, preferably the specific even decoating pattern comprises a grid or an array of open or closed slots or any other design suitable to reduce the reflectance of the coating system.

In some embodiments, the specific odd decoating pattern and the specific even decoating pattern are connected meaning that patterns of two adjacent even and odd coaxial ellipses intersect to give an appealing aesthetic while facilitating the decoating step.

In some embodiments, the specific odd decoating and the specific even decoating are disconnected meaning that patterns of two adjacent even and odd coaxial ellipses do not intersect to ease the decoating process while to avoid interactions between odd and even zones.

FIG. 6 illustrates an embodiment of a Fresnel zone plate lens allowing an oblique incident EM wave, incident from a theta, the angle between the +Z and the line connecting the origin to the base station, of about 120 deg (theta=120 Deg) and a phi, the signed angle measured from +X to the orthogonal projection of the line connecting the origin to the base station on the surface of the dielectric substrate plane (XY plane), of about 135 deg (phi=135 deg), at 28 GHz to be focalized at a distance DLz substantially equals to 40 cm (DLz=40 cm) on the other side of the incoming wave.

The odd coaxial elliptical zones CEZ1, CEZ3, CEZ5, CEZ7 are partially decoated with a specific odd decoating pattern and the even coaxial elliptical zones CEZ2, CEZ4, CEZ6, CEZ8 are not decoated, meaning that the coating system remains untouched in these even coaxial elliptical zones.

In this embodiment, the specific odd pattern is a grid to allow both polarizations to be focalized at the focus.

FIG. 7 illustrates an embodiment of a Fresnel zone plate lens allowing an oblique wave incident from a theta of about 135 deg and a phi of about 90 deg, at 28 GHz to be focalized at a distance DLz of about 100 cm (DLz=100 cm) on the other side of the incoming wave. The odd coaxial elliptical zones CEZ1, CEZ3, CEZ5, CEZ7 are partially decoated with a specific odd decoating pattern and the even coaxial elliptical zones CEZ2, CEZ4, CEZ6, CEZ8 are partially decoated with a specific even decoating pattern.

In this embodiment, the specific odd pattern is vertical parallel lines while the specific even pattern is a grid. Therefore, a horizontally polarized incident wave can pass through the odd and even elliptical zones without focalizing while a vertically polarized incident wave can only pass through the even elliptical zones and are focalized at the focus.

In some embodiments in which the incoming wave is normal incident on the dielectric, the coaxial elliptical zones are concentric circular zones CCZn (CCZ1, CCZ2, CCZ3, CCZ4, CCZ5, CCZ6, CCZ7, CCZ8).

FIG. 8 illustrates an embodiment of a Fresnel zone plate lens composed of eight concentric circular zones. The odd concentric circular zones CCZ1, CCZ3, CCZ5, CCZ7 are not decoated and the even concentric circular zones CCZ2, CCZ4, CCZ6, CCZ8 are partially decoated with a specific even decoating pattern, meaning that the odd concentric circular zones are untouched.

In this embodiment, the specific even pattern is a grid to allow both polarizations to be focalized at the focus.

FIG. 9 illustrates an embodiment of a Fresnel zone plate lens composed of eight concentric circles. The odd concentric circular zones CCZ1, CCZ3, CCZ5, CCZ7 are partially decoated with a specific odd decoating pattern and the even concentric circular zones CCZ2, CCZ4, CCZ6, CCZ8 are partially decoated with a specific even decoating pattern.

In this embodiment, the specific odd pattern is vertical parallel lines while the specific even pattern is a grid. Therefore, a horizontally polarized incident wave can pass through the odd and even elliptical zones without focalizing while a vertically polarized incident wave can only pass through the even elliptical zones and are focalized at the focus.

In some embodiments, the odd decoating pattern on each odd coaxial elliptical zone defines odd coated areas, Oac, and odd decoated areas, Oad, and wherein the ratio between odd decoated areas and the even elliptical zone, the sum of the odd coated areas and the odd decoated areas, equals or is at most 0.25 and at least 0.001 (0.001≤Oad/(Oac+Oad)≤0.25) preferably equals or is at most 0.15.

In some embodiments, the odd decoating pattern on each odd coaxial elliptical zone defines odd coated areas, Oac, and odd decoated areas, Oad, and wherein the ratio between odd decoated areas and the even elliptical zone, the sum of the odd coated areas and the odd decoated areas, equals or is at most 0.25 and at least 0.001 (0.001≤Oad/(Oac+Oad)≤0.25) preferably equals or is at most 0.15.

An embodiments provides a method to decoat a Fresnel zone plate lens 10 on a system 1 according the first aspect of the invention comprised on a coating system 3 disposed on a dielectric substrate 2. Thus this embodiments provides a method to decoat a Fresnel zone plate lens 10 comprised on a coating system 3 disposed on a dielectric substrate 2.

The method comprises an odd decoating step of partially decoating odd coaxial elliptical zones with a specific odd decoating pattern and/or an even decoating step of partially decoating the even elliptical zones with a specific even decoating pattern.

The method is preferably realised in situ, meaning when the system 1 is mounted on a stationary or mobile object.

In some embodiments, the glazing is not coated. To add thermal comfort, a coated film can be applied on the glazing. Then, a Fresnel zone plate lens is realised on this coated film with an odd and/or an even decoating step.

The decoating step can be made by a laser to specifically decoat the specific pattern(s).

In some embodiments, the decoating step can be made by masking parts of the zones, decoating all the zones and then remove the mask. In these embodiments, the coating system is preserved where mask is applied on to create the specific pattern(s).

This method permits to optimize and focalize to a defined location an EM wave inside the stationary or mobile object.

Preferably, the method comprises, before the odd decoating step and/or the even decoating step, a first step of measuring in situ the angle of incidence of the incoming radio signal 101 from an outdoor base station or an outdoor repeater 100 followed by a step of calculating the distance between the coating system and the antenna of the indoor equipment 200 defining a focal point; The distance is calculated in 3D meaning with a component in x-, y- and z-axis, respectively DLx, DLy and DLz and a step of calculating the dimension and the position on the coating system 2 of each zone to decoat.

Preferably, the decoating step(s) are performed by a robot comprising a laser. Such robot permits to decoat in situ.

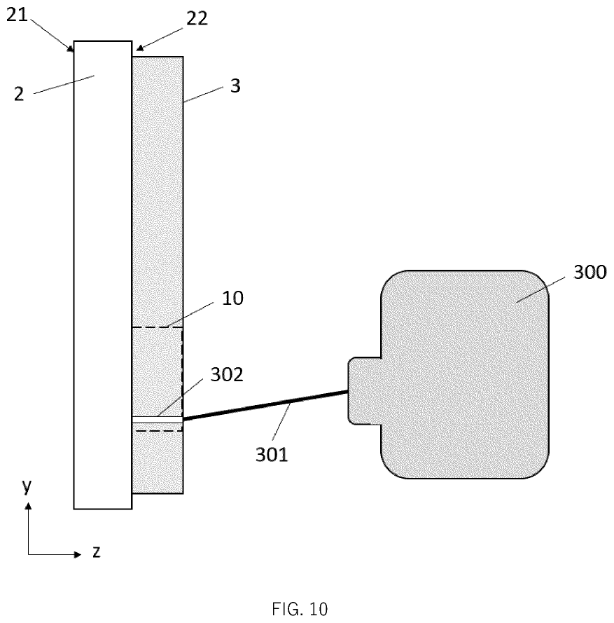

FIG. 10 illustrates a decoating step performed by a robot 300 comprising a laser beam 301. The laser beam removes portion 302 of the coating system 3 to create a Fresnel zone plate lens 10.

The robot is a movable apparatus for removing at least one Fresnel zone plate lens of at least one coating system, meaning that the apparatus can be displaced from a location to another. The apparatus comprises a decoating device including a laser source that generates a laser beam having a specific direction.

In some embodiments, said decoating device can comprise an orientation means configured to control the direction of said laser beam, preferably the orientation means comprises at least a rotatable mirror or a mirrors using a galvanometer based motor. In this way, to decoat the Fresnel zone plate lens is not necessary to use motors to displace the decoating device, the laser beam scans the Fresnel zone plate lens to be decoated thanks to this orientation means. It is not necessarily to displace the decoating device along the x-y plane for decoating the portion. As the decoating device can be fastened to the apparatus, no motor are needed to displace the decoating device along x-y plane. This conducts to a reduction of the weight of the apparatus. Moreover, as only the laser beam is oriented, the scan of the laser beam on the Fresnel zone plate lens is faster than a displacement on the same portion of the decoating device using motors. Thus, the orientation means is able to rapidly decoat a limited coated portion of a coating system.

In some embodiments, the decoating device can move along the x-y plane to control the position of the laser beam.

The robot can be removably attached to the system with for example suction means, such as a vacuum pad or a suction cup. The robot can also be removably attached in at least one border of the system, such as on a wall, or stands behind the system.

In some embodiments, the apparatus can comprise an optical system configured to detect on which interface said coating system is localized, and to estimate a distance between said decoating device and the detected interface. The apparatus can further comprises and a displacement means configured to control the position of said decoating device in the direction normal to the x-y plane. The displacement device can comprise a motor and a displacement control unit, configured to control and displace said decoating device in the direction normal to the x-y plane. The displacement device is configured to displace the decoating device of a displacement distance equal to the difference between the estimated distance and a focus distance in order to focus said decoating device on said detected interface of at least one coating system. To reduce the total weight of the apparatus especially around the decoating device, said displacement device can comprise a mechanical displacement device instead of a motor. Such mechanical displacement device can comprise a screw, preferably with a high precision level, and a displacement control unit. Said displacement control unit can comprises a screen indicating the precise displacement and/or a graduated element and/or a laser.

Thus, the method according to the second aspect of the present invention an comprises before the decoating step a removably attaching step in which the apparatus is removably attached on the system or a presenting step to stand the robot behind the system.

The robot permits to very fast remove a Fresnel zone plate lens of a coating system.

In one embodiment, the apparatus and/or the decoating device can comprise a focusing means to adjust the focus of the laser beam on the coating system to be decoated even if the structure of the dielectric substrate 2 is unknown.

Indeed, to work correctly, the laser source of a decoating system 3 is positioned at a sufficient distance in the Z-axis from the dielectric substrate 2 in order to avoid any degradation during the movements of the decoating device. Typically, the laser is positioned at a working distance of about 160 mm or 250 mm from the dielectric panel.

In order to correctly decoat a coating system, the laser source must be precisely focused onto the targeted coating system. Therefore, the position of the coating system must be known with a precision at least three times smaller than the depth of field of the decoating device. The depth of field corresponds to the distance around the focal point of a focused laser beam where the laser beam diameter is considered constant. This distance depends greatly of the laser beam characteristics and the optics used for focusing said laser beam. Typically, the depth of field is around 0.5 mm, which means that the precision on the focus position of the decoating device should be around 0.1-0.2 mm.

Depending on the decoating device, the width of the ablated paths can be about 20-25 μm, about 40-50 μm, or around 100 μm Considering the variable distance between the support structure and the dielectric substrate and the required precision, the invention proposes to adapt in automatic mode or with precise manual mechanics device the distance between the decoating device and windows before the decoating process to focus the laser beam on the coating system.

Alternatively, to increase to quality of the decoating and to ensure a correct focusing of the laser beam, the apparatus can comprises an optical system configured to detect on which interface said coating system is localized and to estimate a distance between the decoating device and the detected interface; and a displacement means configured to control the position of said decoating device in the direction normal to the x-y plane.

An embodiment provides the use of a system according the first aspect of the invention to focalize an incident EM wave 100 having wavelengths between 0.3 GHz and 110 GHz through the system to an indoor equipment 200 at a desired location, DL.

It is understood that the transmission performance can be further improved by adding at least a dielectric panel and/or a metasurface placed between the indoor equipment and the Fresnel zone plate lens and/or by adding a dielectric panel and/or a metasurface placed between the base station and the Fresnel zone plate lens.

1: A system, comprising:
a dielectric substrate; and
a coating system disposed on the dielectric substrate,
wherein the coating system comprises a Fresnel zone plate lens comprising N coaxial elliptical zones CEZn, n being a positive integer and numbered from 1 to N,
wherein N is a positive integer greater than or equal to 2,
wherein the coaxial elliptical zones include at least one odd coaxial elliptical zone and at least one even coaxial elliptical zone, and
wherein each of the at least one odd coaxial elliptical zone is partially decoated with a specific odd decoating pattern comprising coated and decoated areas and/or each of the at least one even coaxial elliptical zone is partially decoated with a specific even decoating pattern comprising coated and decoated areas.

2: The system according to claim 1, wherein the at least one odd coaxial elliptical zones are partially decoated with a specific odd decoating pattern, and the at least one even coaxial elliptical zones are not decoated.

3: The system according to claim 2, wherein the specific odd decoating pattern comprises an array of one-dimensional periodic structures.

4: The system according to claim 2, wherein the specific odd decoating pattern comprises an array of two-dimensional periodic structures.

5: The system according to claim 1, wherein the at least one even coaxial elliptical zone is partially decoated with a specific even decoating pattern, and the at least one odd coaxial elliptical zone is not decoated.

6: The system according to claim 5, wherein the specific even decoating pattern comprises an array of one-dimensional periodic structures.

7: The system according to claim 5, wherein the specific even decoating pattern comprises an array of two-dimensional periodic structure.

8: The system according to claim 1, wherein the at least one odd elliptical zone is partially decoated with a specific odd decoating pattern, and the at least one even elliptical zone is partially decoated with a specific even decoating pattern, and
wherein the odd decoating pattern and the even decoating pattern are different.

9: The system according to claim 1, wherein the even decoating pattern on each of the at least one even coaxial elliptical zone defines even coated areas, Eac, and even decoated areas, Ead, and
wherein a ratio between the even decoated areas and the sum of the even coated areas and the even decoated areas, equals or is at most 0.25 and at least 0.001 (0.001≤Ead/(Eac+Ead)≤0.25).

10: The system according to claim 1, wherein the odd decoating pattern on each of the at least one odd coaxial elliptical zone defines odd coated areas, Oac, and odd decoated areas, Oad, and
wherein a ratio between the odd decoated areas and the sum of the odd coated areas and the odd decoated areas, equals or is at most 0.25 and at least 0.001 (0.001≤Oad/(Oac+Oad)≤0.25).

11: The system according to claim 1, wherein the coaxial elliptical zones are concentric circular zones.

12: The system according to claim 1, wherein the dielectric substrate is a glazing panel.

13: A method of decoating a Fresnel zone plate lens comprised on a coating system disposed on a dielectric substrate,
wherein the Fresnel zone plate lens comprises N coaxial elliptical zones CEZn, n being a positive integer and numbered from 1 to N,
wherein N is a positive integer greater than or equal to 2,
wherein the coaxial elliptical zones include at least one odd coaxial elliptical zone and at least one even coaxial elliptical zone,
wherein each of the at least one odd coaxial elliptical zone is partially decoated with a specific odd decoating pattern comprising coated and decoated areas and/or the at least one even coaxial elliptical zone is partially decoated with a specific even decoating pattern comprising coated and decoated areas,
wherein the method comprises:
partially decoating the odd coaxial elliptical zones with a specific odd decoating pattern comprising coated and decoated areas;
and/or
partially decoating the even coaxial elliptical zones with a specific even decoating pattern comprising coated and decoated areas.

14: The method of claim 13, wherein the method comprises, before the partially decoating the odd coaxial elliptical zones and/or the partially decoating the even coaxial elliptical zones:
measuring in situ an angle of incidence of an incoming radio signal from an outdoor base station or an outdoor repeater;
calculating a distance between the coating system and an antenna of an indoor equipment defining a focal point; and
calculating a dimension and a position of the elliptical zones to decoat.

15: A method of focalizing an incident EM wave having a wavelength between 0.3 GHz and 110 GHz, the method comprising:
exposing the system of claim 1 to the incident EM wave, wherein the system focalizes the incident EM wave to a desired location, and
wherein an indoor equipment is located on the other side of the dielectric substrate than the incident EM wave.
